(19) United States
(12) Patent Application Publication
(10) Pub. No.: US 2025/0075769 A1
(43) Pub. Date: Mar. 6, 2025

(54) METHODS AND APPARATUS FOR POSITION SENSITIVE SUSPENSION DAMPING

(71) Applicant: Fox Factory, Inc., Duluth, GA (US)

(72) Inventors: Everet Owen Ericksen, Woodland, CA (US); Christopher Paul Cox, Capitola, CA (US); Sante M. Pelot, Freedom, CA (US)

(73) Assignee: Fox Factory, Inc., Duluth, GA (US)

(21) Appl. No.: 18/382,966

(22) Filed: Oct. 23, 2023

Related U.S. Application Data
(63) Continuation of application No. 16/893,256, filed on Jun. 4, 2020, now Pat. No. 11,796,028.
Application No. 16/893,256 is a continuation of application No. 14/506,420, filed on Oct. 3, 2014, now Pat. No. 10,677,309.
Application No. 14/506,420 is a division of application No. 13/485,401, filed on May 31, 2012, now abandoned.
(60) Provisional application No. 61/491,858, filed on May 31, 2011.

(51) Int. Cl. F16F 9/48; B62K 25/06; F16F 9/34; F16F 9/46

(52) U.S. Cl. CPC F16F 9/486; B62K 25/06; F16F 9/3405; F16F 9/46

(57) ABSTRACT

An apparatus and system are disclosed that provide position sensitive suspension damping. A damping unit includes a piston mounted in a fluid-filled cylinder. A vented path in the piston may be fluidly coupled to a bore formed in one end of the piston rod, creating a flow path for fluid to flow from a first side of the piston to a second side of the piston during a compression stroke. The flow path may be blocked by a needle configured to engage the bore as the damping unit is substantially fully compressed, thereby causing the damping rate of the damping unit to increase. In one embodiment, the piston includes multiple bypass flow paths operable during the compression stroke or the rebound stroke of the damping unit. One or more of the bypass flow paths may be restricted by one or more shims mounted on the piston.

### CROSS-REFERENCE TO RELATED APPLICATIONS

This application claims priority to and is a Continuation of the co-pending patent application Ser. No. 16/893,256, Attorney Docket Number FOX-0055USD1C1 entitled “METHODS AND APPARATUS FOR POSITION SENSITIVE SUSPENSION DAMPING,” with filing date Jun. 4, 2020, by Everet Owen Ericksen et al., which is incorporated herein, in its entirety, by reference.

The application with Ser. No. 16/893,256 claims priority to and is a Continuation of the patent application Ser. No. 14/506,420, now U.S. Issued U.S. Pat. No. 10,677,309, Attorney Docket Number FOX-0055USD1, entitled “METHODS AND APPARATUS FOR POSITION SENSITIVE SUSPENSION DAMPING,” with filing date Oct. 3, 2014, by Everet Owen Ericksen et al., which is incorporated herein, in its entirety, by reference.

The application with Ser. No. 14/506,420 claims priority to and is a Divisional of the patent application Ser. No. 13/485,401, now Abandoned, Attorney Docket Number FOXF/0055US, entitled “METHODS AND APPARATUS FOR POSITION SENSITIVE SUSPENSION DAMPING”, with filing date May 31, 2012, by Everet Owen Ericksen et al., which is incorporated herein, in its entirety, by reference.

The application with Ser. No. 13/485,401 claims priority to the patent application, Ser. No. 61/491,858, Attorney Docket Number FOXF/0055USL entitled “METHODS AND APPARATUS FOR POSITION SENSITIVE SUSPENSION DAMPING”, with filing date May 31, 2011, by Everet Owen Ericksen et al., which is incorporated herein, in its entirety, by reference.

### BACKGROUND OF THE INVENTION

### Field of the Invention

The invention relates generally to vehicle suspensions and, more specifically, to variable damping rates in vehicle shock absorbers and forks.

### Description of the Related Art

Vehicle suspension systems typically include a spring component or components and a damping component or components. Often, mechanical springs, like helical springs, are used with some type of viscous fluid-based damping mechanism, the spring and damper being mounted functionally in parallel. In some instances a spring may comprise pressurized gas and features of the damper or spring are user-adjustable, such as by adjusting the air pressure in a gas spring. A damper may be constructed by placing a damping piston in a fluid-filled cylinder (e.g., liquid such as oil). As the damping piston is moved in the cylinder, fluid is compressed and passes from one side of the piston to the other side. Often, the piston includes vents there-through which may be covered by shim stacks to provide for different operational characteristics in compression or extension.

Conventional damping components provide a constant damping rate during compression or extension through the entire length of the stroke. As the suspension component nears full compression or full extension, the damping piston can “bottom out” against the end of the damping cylinder. Allowing the damping components to “bottom out” may cause the components to deform or break inside the damping cylinder.

As the foregoing illustrates, what is needed in the art are improved techniques for varying the damping rate including to lessen the risk of the suspension “bottoming out.”

### SUMMARY OF THE INVENTION

One embodiment of the present disclosure sets forth a vehicle suspension damper that includes a cylinder having a compression chamber and a rebound chamber and containing at least a portion of a piston rod having a piston attached thereto, where an outer diameter of the piston engages an inner diameter of the cylinder and is relatively movable therein, and where the piston borders each of the compression chamber and the rebound chamber. The vehicle suspension damper further includes a damping liquid within the cylinder and a bypass fluid flow path connecting the compression chamber and the rebound chamber, which forms a fluid path extending between an inner diameter of the piston and a side surface of the piston directly bordering one of the compression or rebound chambers.

Another embodiment of the present disclosure sets forth a vehicle suspension damper that includes a cylinder and a damping liquid within the cylinder, the cylinder having a compression chamber and a rebound chamber and containing at least a portion of a piston rod having a piston attached thereto, where an outer diameter of the piston engages an inner diameter of the cylinder and is relatively movable therein, and where the piston borders each of the compression chamber and the rebound chamber. The piston includes multiple flow paths that enable the damping liquid to flow from the compression chamber to the rebound chamber. The multiple flow paths include a damping flow path that comprises a first fluid path extending between a first side surface of the piston directly bordering the compression chamber and a second side surface of the piston directly bordering the rebound chamber and a bypass flow path that comprises a fluid path extending between an inner diameter of the piston and one of the first side surface of the piston or the second side surface of the piston.

Yet another embodiment of the present disclosure sets forth a vehicle suspension system that includes a first damper unit. The first damper unit includes a cylinder having a compression chamber and a rebound chamber and containing at least a portion of a piston rod having a piston attached thereto, wherein an outer diameter of the piston engages an inner diameter of the cylinder and is relatively movable therein, and wherein the piston borders each of the compression chamber and the rebound chamber. The first damper unit further includes a damping liquid within the cylinder and a bypass fluid flow path connecting the compression chamber and the rebound chamber, which forms a fluid path extending between an inner diameter of the piston and a side surface of the piston directly bordering one of the compression or rebound chambers.

One advantage of some disclosed embodiments is that multiple bypass flow paths enable the vehicle suspension damper to be setup such that the damping rate changes (i.e., is increased) as the damper nears full compression. The increased damping rate, caused by fluid being forced through fewer flow paths formed by the multiple bypass flow paths causes the force opposing further compression of the damper to increase, thereby decreasing the chance that the damper “bottoms out.”

### BRIEF DESCRIPTION OF THE DRAWINGS

So that the manner in which the above recited features can be understood in detail, a more particular description, briefly summarized above, may be had by reference to certain example embodiments, some of which are illustrated in the appended drawings. It is to be noted, however, that the appended drawings illustrate only typical embodiments and are therefore not to be considered limiting the scope of the claims, which may admit to other equally effective embodiments.

FIG. 1 shows an asymmetric bicycle fork having a damping leg and a spring leg, according to one example embodiment;

FIGS. 2A-2C show sectional side elevation views of a needle-type monotube damping unit in different stages of compression, according to one example embodiment;

FIG. 3 shows a detailed view of the needle and bore at the intermediate position proximate to the “bottom-out” zone, according to one example embodiment;

FIGS. 4A and 4B illustrate the castellated or slotted valve, according to one example embodiment;

FIGS. 5A and 5B illustrate a damping unit having a “piggy back” reservoir, according to one example embodiment;

FIG. 6 illustrates a half section, orthographic view of a damping unit, according to another example embodiment;

FIGS. 7A through 7E illustrate the piston of FIG. 6, according to one example embodiment; and

FIGS. 8A and 8B illustrate the shaft of FIG. 6, according to one example embodiment.

For clarity, identical reference numbers have been used, where applicable, to designate identical elements that are common between figures. It is contemplated that features of one example embodiment may be incorporated in other example embodiments without further recitation.

### DETAILED DESCRIPTION

Integrated damper/spring vehicle shock absorbers often include a damper body surrounded by or used in conjunction with a mechanical spring or constructed in conjunction with an air spring or both. The damper often consists of a piston and shaft telescopically mounted in a fluid filled cylinder. The damping fluid (i.e., damping liquid) or damping liquid may be, for example, hydraulic oil. A mechanical spring may be a helically wound spring that surrounds or is mounted in parallel with the damper body. Vehicle suspension systems typically include one or more dampers as well as one or more springs mounted to one or more vehicle axles. As used herein, the terms “down”, “up”, “downward”, “upward”, “lower”, “upper”, and other directional references are relative and are used for reference only.

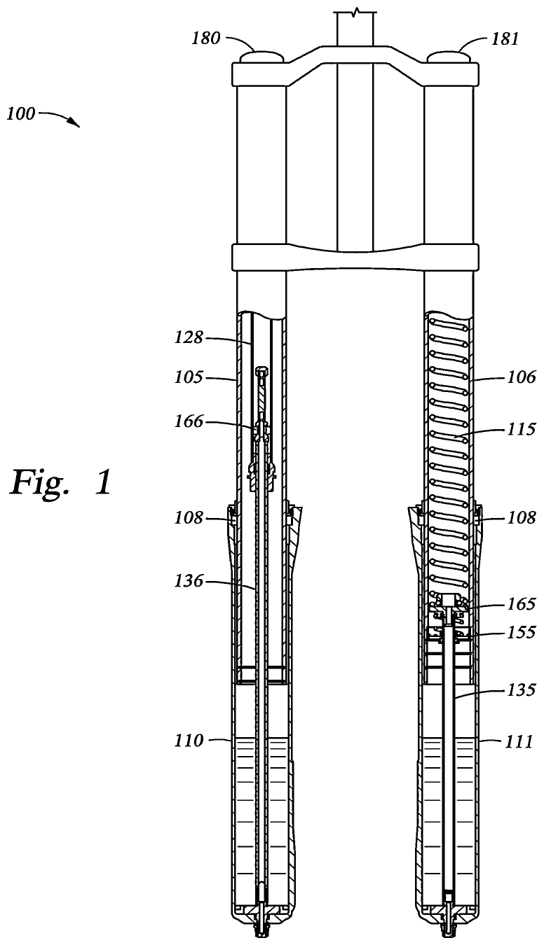

FIG. 1 shows an asymmetric bicycle fork 100 having a damping leg and a spring leg, according to one example embodiment. The damping leg includes an upper tube 105 mounted in telescopic engagement with a lower tube 110 and having fluid damping components therein. The spring leg includes an upper tube 106 mounted in telescopic engagement with a lower tube 111 and having spring components therein. The upper legs 105, 106 may be held centralized within the lower legs 110, 111 by an annular bushing 108. The fork 100 may be included as a component of a bicycle such as a mountain bicycle or an off-road vehicle such as an off-road motorcycle. In some embodiments, the fork 100 may be an “upside down” or Motocross-style motorcycle fork.

In one embodiment, the damping components inside the damping leg include an internal piston 166 disposed at an upper end of a damper shaft 136 and fixed relative thereto. The internal piston 166 is mounted in telescopic engagement with a cartridge tube 128 connected to a top cap 180 fixed at one end of the upper tube 105. The interior volume of the damping leg may be filled with a damping liquid such as hydraulic oil. The piston 166 may include shim stacks (i.e., valve members) that allow a damping liquid to flow through vented paths in the piston 166 when the upper tube 105 is moved relative to the lower tube 110. A compression chamber is formed on one side of the piston 166 and a rebound chamber is formed on the other side of the piston 166. The pressure built up in either the compression chamber or the rebound chamber during a compression stroke or a rebound stroke provides a damping force that opposes the motion of the fork 100.

The spring components inside the spring leg include a helically wound spring 115 contained within the upper tube 106 and axially restrained between top cap 181 and a flange 165. The flange 165 is disposed at an upper end of the riser tube 135 and fixed thereto. The lower end of the riser tube 135 is connected to the lower tube 111 in the spring leg and fixed relative thereto. A valve plate 155 is positioned within the upper leg tube 106 and axially fixed thereto such that the plate 155 moves with the upper tube 106. The valve plate 155 is annular in configuration, surrounds an exterior surface of the riser tube 135, and is axially moveable in relation thereto. The valve plate 155 is sealed against an interior surface of the upper tube 106 and an exterior surface of the riser tube 135. A substantially incompressible lubricant (e.g., oil) may be contained within a portion of the lower tube 111 filling a portion of the volume within the lower tube 111 below the valve plate 155. The remainder of the volume in the lower tube 111 may be filled with gas at atmospheric pressure.

During compression of fork 100, the gas in the interior volume of the lower tube 111 is compressed between the valve plate 155 and the upper surface of the lubricant as the upper tube 106 telescopically extends into the lower tube 111. The helically wound spring 115 is compressed between the top cap 181 and the flange 165, fixed relative to the lower tube 111. The volume of the gas in the lower tube 111 decreases in a nonlinear fashion as the valve plate 155, fixed relative to the upper tube 106, moves into the lower tube 111. As the volume of the gas gets small, a rapid build-up in pressure occurs that opposes further travel of the fork 100. The high pressure gas greatly augments the spring force of spring 115 proximate to the “bottom-out” position where the fork 100 is fully compressed. The level of the incompressible lubricant may be set to a point in the lower tube 111 such that the distance between the valve plate 155 and the level of the oil is substantially equal to a maximum desired travel of the fork 100.

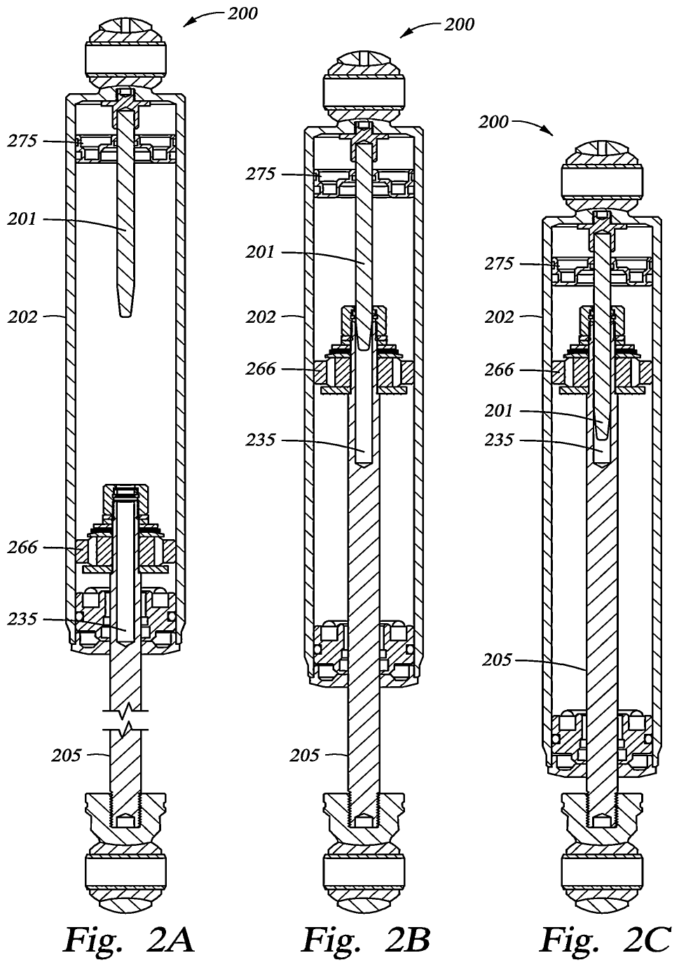

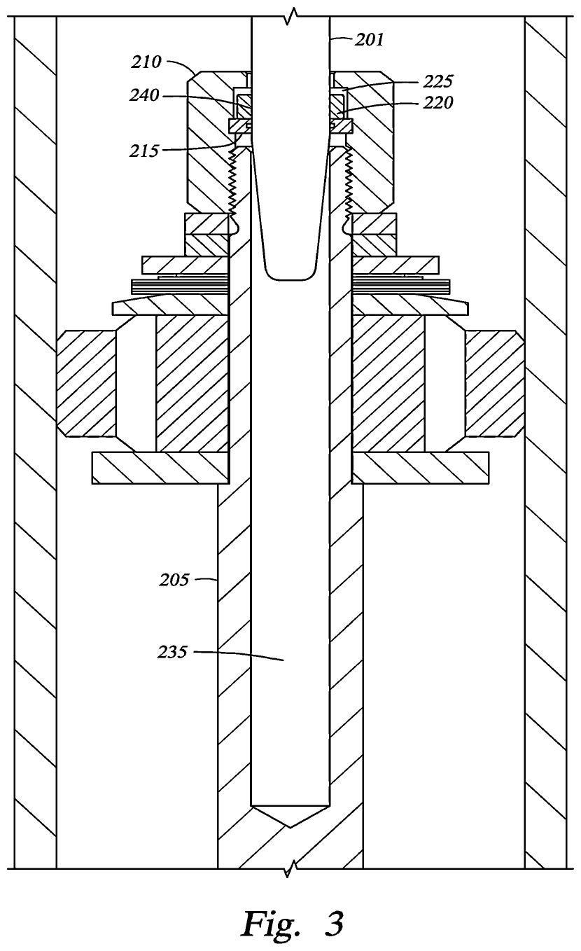

FIGS. 2A-2C show sectional side elevation views of a needle-type monotube damping unit 200 in different stages of compression, according to one example embodiment. In one embodiment, the components included in damping unit 200 may be implemented as one half of fork 100. In another embodiment, damping unit 200 may be implemented as a portion of a shock absorber that includes a helically-wound, mechanical spring mounted substantially coaxially with the damping unit 200. In yet other embodiments, damping unit 200 may be implemented as a component of a vehicle suspension system where a spring component is mounted substantially in parallel with the damping unit 200.

As shown in FIG. 2A, the damping unit 200 is positioned in a substantially fully extended position. The damping unit 200 includes a cylinder 202, a shaft 205, and a piston 266 fixed on one end of the shaft 205 and mounted telescopically within the cylinder 202. The outer diameter of piston 266 engages the inner diameter of cylinder 202. In one embodiment, the damping liquid (e.g., hydraulic oil or other viscous damping fluid) meters from one side to the other side of the piston 266 by passing through vented paths formed in the piston 266. Piston 266 may include shims (or shim stacks) to partially obstruct the vented paths in each direction (i.e., compression or rebound). By selecting shims having certain desired stiffness characteristics, the damping effects can be increased or decreased and damping rates can be different between the compression and rebound strokes of the piston 266. The damping unit 200 includes an annular floating piston 275 mounted substantially co-axially around a needle 201 and axially movable relative thereto. The needle 201 is fixed on one end of the cylinder 202 opposite the shaft 205. A volume of gas is formed between the floating piston 275 and the end of cylinder 202. The gas is compressed to compensate for motion of shaft 205 into the cylinder 202, which displaces a volume of damping liquid equal to the additional volume of the shaft 205 entering the cylinder 202.

During compression, shaft 205 moves into the cylinder 202, causing the damping liquid to flow from one side of the piston 266 to the other side of the piston 266 within cylinder 202. FIG. 2B shows the needle 201 and shaft 205 at an intermediate position as the damping unit 200 has just reached the “bottom-out” zone. In order to prevent the damping components from “bottoming out”, potentially damaging said components, the damping force resisting further compression of the damping unit 200 is substantially increased within the “bottom-out” zone. The needle 201 (i.e., a valve member) compresses fluid in a bore 235, described in more detail below in conjunction with FIG. 3, thereby drastically increasing the damping force opposing further compression of the damping unit 200. Fluid passes out of the bore around the needle through a valve that is restricted significantly more than the vented paths through piston 266. As shown in FIG. 2C, the damping rate is increased substantially within the “bottom-out” zone until the damping unit 200 reaches a position where the damping unit 200 is substantially fully compressed.

FIG. 3 shows a detailed view of the needle 201 and bore 235 at the intermediate position proximate to the “bottom-out” zone, according to one example embodiment. As shown in FIG. 3, the needle 201 is surrounded by a check valve 220 contained within a nut 210 fixed on the end of shaft 205. During compression within the “bottom out” zone, the valve 220 is moved, by fluid pressure within the bore 235 and flow of fluid out of bore 235, upward against seat 225 of nut 210 and the bulk of escaping fluid must flow through the annular clearance 240 that dictates a rate at which the needle 201 may further progress into bore 235, thereby substantially increasing the damping rate of the damping unit 200 proximate to the “bottom-out” zone. The amount of annular clearance 240 between the exterior surface of the needle 201 and the interior surface of the valve 220 determines the additional damping rate within the “bottom-out” zone caused by the needle 201 entering the bore 235. In one embodiment, the needle 201 is tapered to allow easier entrance of the needle 201 into the bore 235 through valve 220.

During rebound within the “bottom out” zone, fluid pressure in the bore 235 drops as the needle 201 is retracted and fluid flows into the bore 235, causing the valve 220 to move toward a valve retainer clip 215 that secures the valve 220 within the nut 210. In one embodiment, the valve is castellated or slotted on the face of the valve 220 adjacent to the retainer clip 215 to prevent sealing the valve against the retainer clip 215, thereby forcing all fluid to flow back into the bore 235 via the annular clearance 240. Instead, the castellation or slot allows ample fluid flow into the bore 235 during the rebound stroke to avoid increasing the damping rate during rebound within the “bottom out” zone. The valve 220 is radially retained within the nut 210, which has a recess having a radial clearance between the interior surface of the recess and the exterior surface of the valve 220 that allows for eccentricity of the needle 201 relative to the shaft 205 without causing interference that could deform the components of damping unit 200.

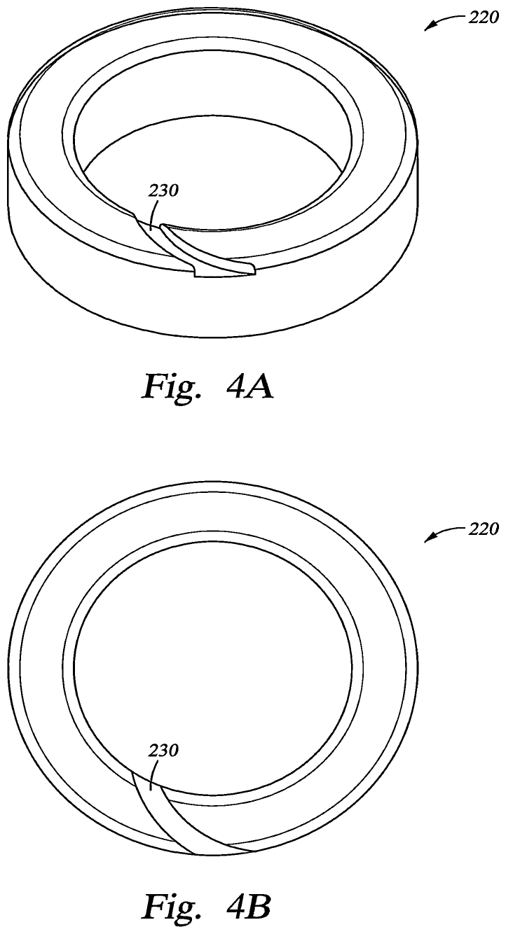

FIGS. 4A and 4B illustrate the castellated or slotted valve 220, according to one example embodiment. As shown in FIGS. 4A and 4B, the valve 220 is a washer or bushing having an interior diameter sized to have an annular clearance 240 between the interior surface of the valve 220 and the exterior surface of the needle 201 when the needle 201 passes through the valve 220. Different clearances 240 may be achieved by adjusting the interior diameter of the valve 220 in comparison to the diameter of the needle 201, which causes a corresponding change in the damping rate proximate to the “bottom-out” zone. A spiral face groove is machined into one side of the valve 220 to create the castellation or slot 230. It will be appreciated that the geometry of the slot 230 may be different in alternative embodiments and is not limited to the spiral design illustrated in FIGS. 4A and 4B. For example, the slot 230 may be straight (i.e., rectangular) instead of spiral, or the edges of the slot 230 may not be perpendicular to the face of the valve 220. In other words, the geometry of the slot 230 creates empty space between the surface of the retainer clip 215 and the surface of the valve 220 such that fluid may flow between the two surfaces.

When assembled, the valve 200 is oriented such that the side with the slot 230 is proximate to the upper face of the valve retainer clip 215, thereby preventing the surface of the valve 220 from creating a seal against the retainer clip 215. The slot 230 is configured to allow fluid to flow from cylinder 202 to bore 235 around the exterior surface of the valve 220, which has a larger clearance than the annular clearance 240 between the valve 220 and the needle 201. In one embodiment, two or more slots 230 may be machined in the face of the valve 220. In some embodiments, the valve 220 is constructed from high-strength yellow brass (i.e., a manganese bronze alloy) that has good characteristics enabling low friction between the valve 220 and the needle 201. In alternate embodiments, the valve 220 may be constructed from other materials having suitable characteristics of strength or coefficients of friction.

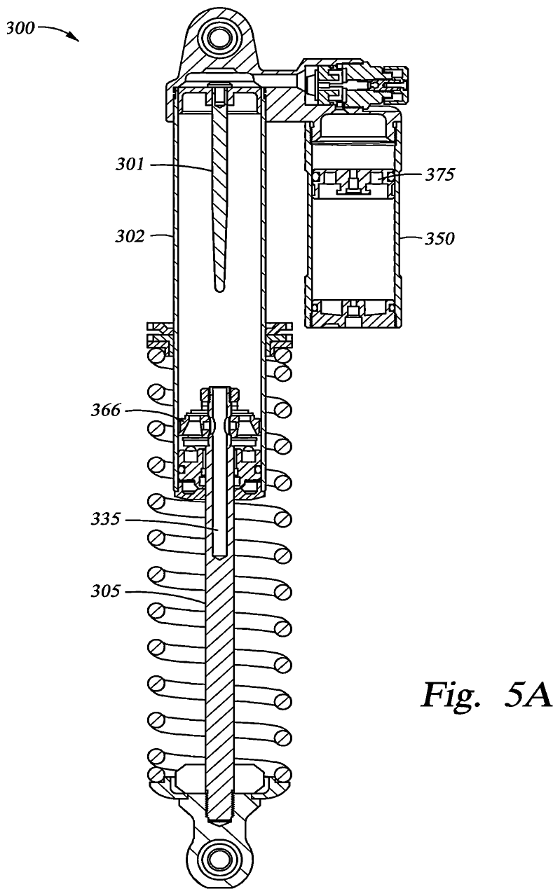

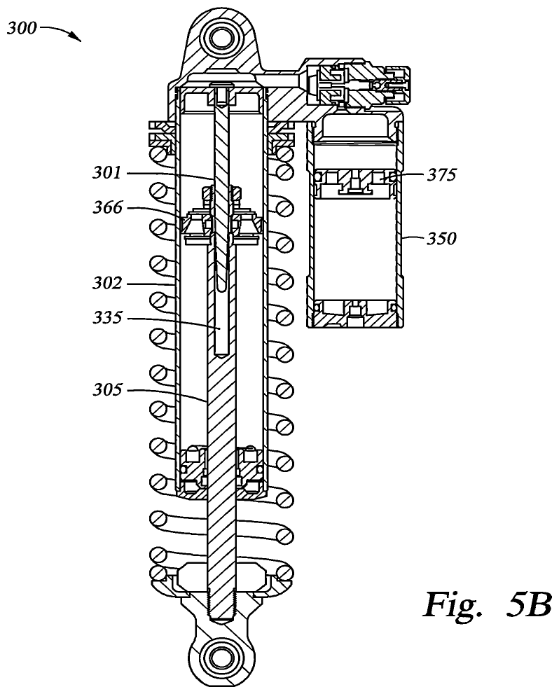

FIGS. 5A and 5B illustrate a damping unit 300 having a “piggy back” reservoir 350, according to another example embodiment. As shown in FIG. 5A, damping unit 300, shown fully extended, includes a cylinder 302 with a shaft 305 and a piston 366 fixed on one end of the shaft 305 and mounted telescopically within the cylinder 302. Damping unit 300 also includes a needle 301 configured to enter a bore 335 in shaft 305. However, unlike damping unit 200, damping unit 300 does not include an annular floating piston mounted substantially co-axially around the needle 301 and axially movable relative thereto. Instead, the piggy back reservoir 350 includes a floating piston 375 configured to perform a similar function to that of floating piston 275. A volume of gas is formed between the floating piston 375 and one end of the piggy back reservoir 350. The gas is compressed to compensate for motion of shaft 305 into the cylinder 302. Excess damping liquid may enter or exit cylinder 302 from the piggy back reservoir 350 as the volume of fluid changes due to ingress or egress of shaft 305 from the cylinder 302. In FIG. 5B, the damping unit 300 is shown proximate to the “bottom out” zone where needle 301 has entered bore 335.

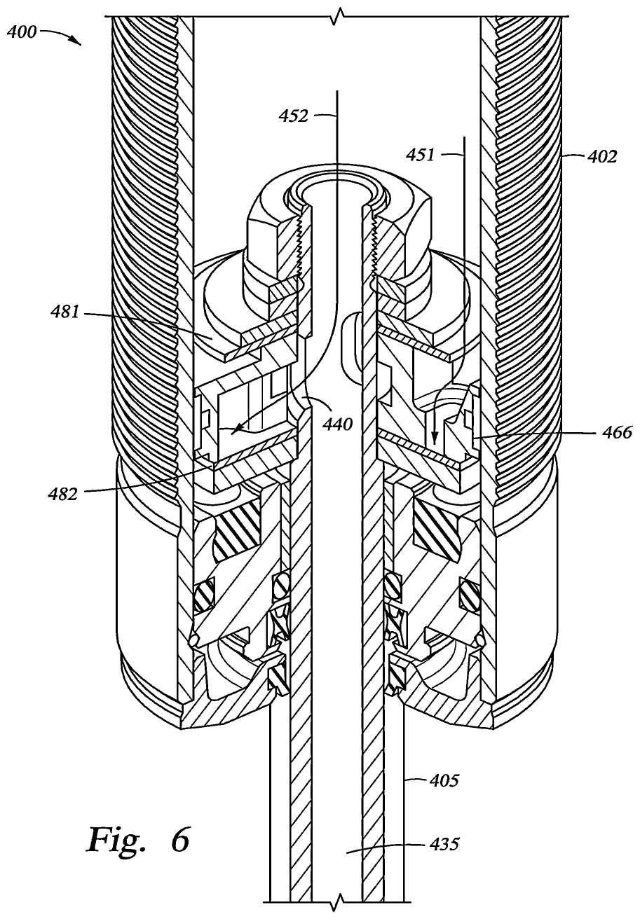

FIG. 6 illustrates a half section, orthographic view of a damping unit 400, according to another example embodiment. As shown in FIG. 6, damping unit 400 includes a piston 466 fixed on one end of a shaft 405 and mounted telescopically within a cylinder 402. The shaft 405 includes a bore 435 that enables ingress of a needle (e.g., 201, 301) to change the damping characteristics of the damping unit 400 proximate to the “bottom out” zone. The piston assembly includes a top shim stack 481 and a bottom shim stack 482 attached to the top face and bottom face of the piston 466, respectively, which enable different damping resistances to be set during the compression stroke and the rebound stroke. During operation, where a needle has not entered bore 435, the damping liquid flows from one side of the piston 466 to the other side through multiple flow paths 451, 452, and 453. In compression, a first flow path 451 (i.e., a damping flow path) allows the damping liquid to flow from an upper portion of the cylinder 402 through vented paths in the piston 466 and into a lower portion of the cylinder 402, forcing the bottom shim stack 482 away from the bottom face of the piston 466. A second flow path 452 (i.e., a bypass flow path) allows the damping liquid to flow from an upper portion of the cylinder 402 through the bore 435 and shaft ports 440 in shaft 405 and into additional vented paths in the piston 466 through the bottom shim stack 482 and into the lower portion of the cylinder 402. In rebound, a third flow path 453 (i.e., a rebound flow path, not shown in FIG. 6) allows the damping liquid to flow from a lower portion of the cylinder 402, through different vented paths in the piston 466, through the top shim stack 481, and into an upper portion of the cylinder 402. In some embodiments, the first flow path 451 and the second flow path 452 may be associated with separate and distinct shim stacks. For example, the bottom shim stack 482 may be replaced by two shim stacks configured in a clover pattern and arranged such that a first shim stack covers the vented paths in the piston 466 corresponding to the first flow path 451 and a second shim stack covers the additional vented paths in the piston 466 corresponding to the second flow path 452.

When a needle just enters bore 435, the needle impedes the damping liquid in the upper portion of the cylinder 402 from flowing through the second flow path 452 due to the “plugging” effect of the needle blocking the entrance to the bore 435. However, the damping liquid may continue to pass through the piston 466 through the first flow path 451. In addition, some damping liquid may continue to flow out of ports 440 from bore 435 as the needle continues ingress into bore 435 and decreases the fluid volume inside the bore 435. It will be appreciated that the damping rate will increase as the needle blocks the second flow path 452, thereby forcing substantially all damping liquid in the upper portion of the cylinder 402 to move through piston 466 via the first flow path 451. At some point during ingress of the needle, the full diameter of the needle is adjacent to the shaft ports 440, substantially blocking additional damping liquid from leaving bore 435 through the shaft ports 440. Again, the damping rate will increase as the needle blocks the shaft ports 440 and fluid pressure rapidly builds up within bore 435 and acts on the needle to oppose any further compression of the damping unit 400.

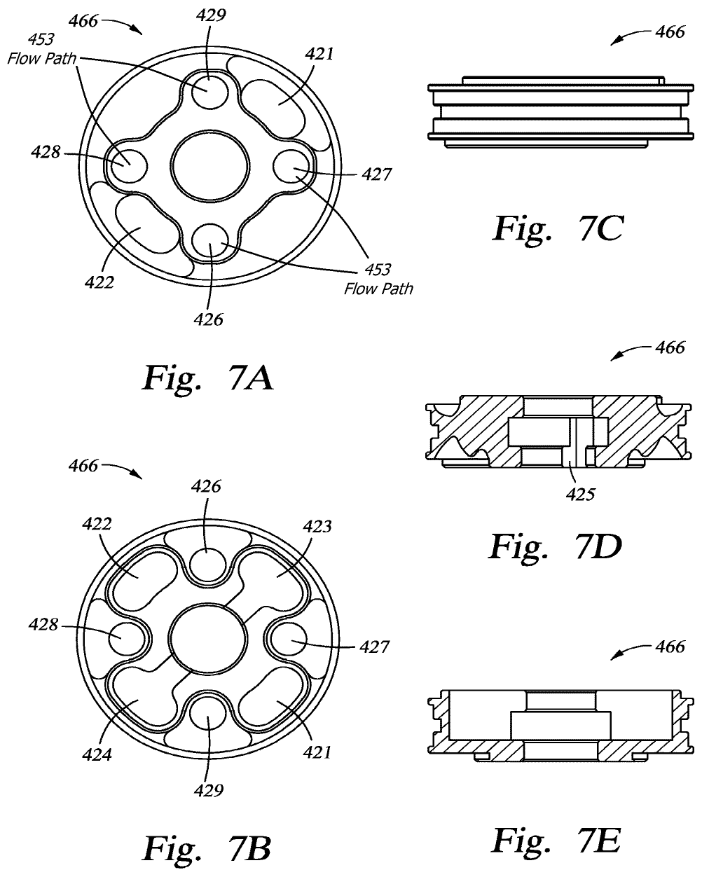

FIGS. 7A through 7E illustrate the piston 466 of FIG. 6, according to one example embodiment. As shown in FIGS. 7A and 7B, the piston 466 includes two vented paths (i.e., 421, 422) that allow damping liquid to flow from the upper portion of the cylinder 402 to the lower portion of the cylinder 402 via the first flow path 451 (i.e., bypassing the top shim stack and entering the piston 466 proximate to the inner surface of cylinder 402). The piston 466 also includes two additional vented paths (i.e., 423, 424) that allow damping liquid to flow from the upper portion of the cylinder 402 to the lower portion of the cylinder 402 via the second flow path 452 (i.e., through the bore 435 and shaft ports 440). The additional vented paths are connected to the bore 435 via channels 425 that fluidly couple the additional vented paths to the shaft ports 440 in shaft 405 through a surface on the inner diameter of the piston 466. The four vented paths described above (i.e., 421-424) allow damping liquid to flow from an upper portion of the cylinder 402 to a lower portion of the cylinder 402 during a compression stroke. In rebound, yet another set of four vented paths (i.e., 426, 427, 428, 429) allow damping liquid to flow from the lower portion of the cylinder 402 to the upper portion of the cylinder 402 via the third flow path 453 (i.e., bypassing the bottom shim stack 482 and passing into the upper portion of the cylinder 402 through the top shim stack 481). FIG. 7C shows a side view of the piston 466 of FIGS. 7A and 7B. FIG. 7D shows a cross section of the piston 466 showing the inner diameter that is fit over shaft 405 as well as one channel 425 connected to one of the additional vented paths in the piston corresponding to the first second flow path 452. FIG. 7E shows a cross section of the piston 466 showing vented paths 423 and 424.

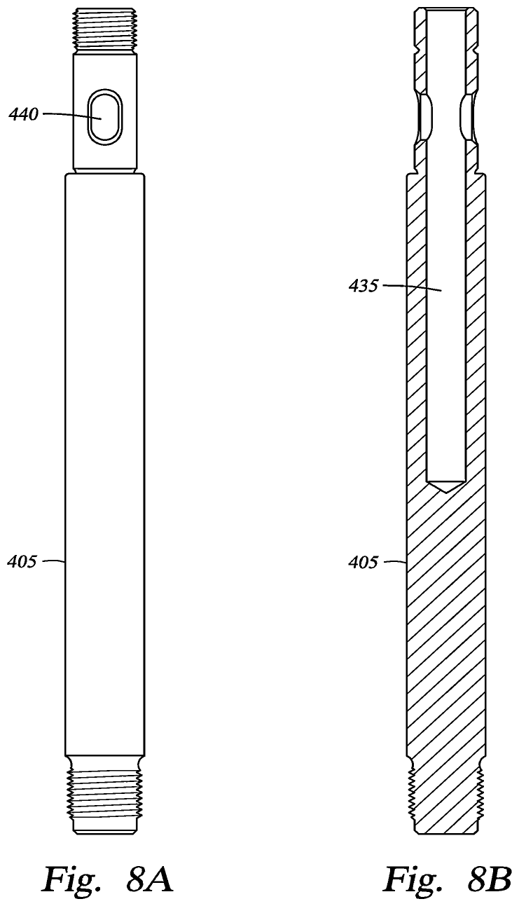

FIGS. 8A and 8B illustrate the shaft 405 of FIG. 6, according to one example embodiment. As shown in FIGS. 8A and 8B, the shaft 405 includes a bore 435 formed (e.g., drilled, milled, etc.) into a top portion of the shaft. In one embodiment, the top portion of the shaft may have a smaller diameter than the body of the shaft 405, forming a seat a particular distance from one end of the shaft 405. The piston assembly including the piston 466 and the shim stacks may be mounted over the top portion of the shaft 405 and secured with a nut threaded onto the end of the shaft 405. In alternative embodiments, the nut may be press fit onto the shaft 405 or secured in any other technically feasible manner.

Shaft ports 440 may be formed through an outer face of the top portion of the shaft 405 proximate a surface on the inner diameter of the piston 466 when mounted on the shaft 405. The shaft ports 440 fluidly couple the bore 435 in the shaft 405 with the additional vented paths (i.e., 423, 424) in the piston 466 such that fluid may flow through the bore 435 via the second flow path 452. In other words, the second flow path 452 enables additional fluid to flow through the bottom shim stacks 482 when a needle is not blocking the bore 435.

It should be noted that any of the features disclosed herein may be used alone or in combination. While the foregoing is directed to embodiments of the present disclosure, other and further embodiments may be implemented without departing from the scope of the disclosure, the scope thereof being determined by the claims that follow.

What we claim is:

1. A vehicle suspension damper comprising:
a cylinder containing damping fluid and a piston assembly comprising:
a piston;
a piston rod;
a first fluid path through said piston assembly and a second fluid path through said piston assembly, said first fluid path and said second fluid path for permitting damping fluid to pass from a first side of said piston to a second side of said piston during a compression stroke of said vehicle suspension damper;
a valve member for resisting fluid flow through said second fluid path, wherein said valve member is moved into a bore during compression and out of said bore during extension, so as to displace at least some of said damping fluid through said first fluid path and said second fluid path, and wherein said valve member comprises a needle member sized to be inserted into said bore and withdrawn from said bore, whereby a restriction to fluid flow through said second fluid path is generated, said restriction being independent of pressure of said damping fluid caused by compression of said vehicle suspension damper, said bore comprises a blind bore and, in use as said valve member is moved into said bore during compression said valve member firstly begins to block said second fluid path, thereby forcing said damping fluid to flow through said piston via said first fluid path, and secondly said valve member blocks said second fluid path, thereby blocking additional damping fluid from leaving said bore via said second fluid path such that fluid pressure builds up within said bore to oppose any further compression of said damper;
a floating piston surrounding said needle member, and
a slotted, ring-shaped check valve fluidically coupled to said piston.
